(19) United States
(12) Patent Application Publication
(10) Pub. No.: US 2017/0173764 A1
(43) Pub. Date: Jun. 22, 2017

(54) EXTENSION ELEMENT FOR IMPROVED USE OF AN ADJUSTABLE WRENCH

(71) Applicant: Thru Tubing Solutions, Inc., Oklahoma City, OK (US)

(72) Inventors: Brock Watson, Okahoma City, OK (US); Roger Schultz, Newcastle, OK (US); Greg Kliewer, Edmond, OK (US); Andy Ferguson, Moore, OK (US)

(21) Appl. No.: 15/127,344

(22) PCT Filed: Apr. 20, 2015
(86) PCT No.: PCT/US2015/026715

§ 371 Date: Sep. 19, 2016

Related U.S. Application Data
(60) Provisional application No. 61/981,284, filed on Apr. 18, 2014.

(51) Int. Cl. B25B 13/50; B25B 29/00

(52) U.S. Cl. CPC B25B 13/5058; B25B 29/00

(57) ABSTRACT

This disclosure is related to an adjustable wrench for engaging work objects. The adjustable wrench has a handle having a handle end and a flat serrated jaw surface. The adjustable wrench also has an L-shaped movable jaw having a lever arm and a serrated jaw, the lever arm having a terminal end and an extension element extending from the terminal end having an opening therethrough. The adjustable wrench further comprises a projection extending from the handle having a tunnel therein for accepting the lever arm of the L-shaped movable jaw and a grip enhancing apparatus.

### BACKGROUND OF THE DISCLOSURE

Field of the Invention

The present disclosure relates to an adjustable wrench that includes an extension device to permit better performance of a grip enhancing apparatus used with the adjustable wrench to better engage a work object.

Description of the Related Art

Traditionally, pipe wrenches are adjustable wrenches used for fitting and turning rounded surfaces. A user manipulates the wrench to fit the rounded surface and then must apply pressure to the wrench to engage the rounded surface and turn it. If a user does not continue to apply force to the wrench, the wrench will not stay engaged on the rounded surface and would fall to the ground if the user does not hold it. Accordingly, there is a need for a wrench that can stay engaged on a rounded surface without the user having to hold the wrench and continually apply pressure to the wrench.

### SUMMARY OF THE DISCLOSURE

The present disclosure is directed to an adjustable wrench for engaging a work object. The wrench includes a handle having a handle end and a flat serrated jaw surface. The wrench also includes an L-shaped movable jaw having a lever arm and a serrated jaw, the lever arm having a terminal end with an extension device extending therefrom and an opening in the extension device. The wrench further includes a projection extending from the handle having a tunnel therein for accepting the lever arm of the L-shaped movable jaw. Additionally, the wrench includes a grip enhancing apparatus. The grip enhancing apparatus can have numerous designs. In one embodiment, the grip enhancing apparatus includes a threaded nut element disposed adjacent to the extension device, the threaded nut element having a threaded opening therein. The grip enhancing apparatus also includes a threaded shaft for extending through the opening of the extension device and engaging the threaded opening of the threaded nut element. The threaded shaft can extend through the threaded nut element and contact the handle of the adjustable wrench, forcing the L-shaped movable jaw away from the handle and the serrated jaw of the L-shaped movable jaw is forced toward the flat serrated jaw surface.

The present disclosure is directed to an adjustable wrench for engaging a work object. The wrench includes an opening, a handle having a handle end and a flat serrated jaw surface. The wrench also includes an L-shaped movable jaw having a lever arm and a serrated jaw, the lever arm having a terminal end. The wrench further includes a projection extending from the handle having a tunnel therein for accepting the lever arm of the L-shaped movable jaw. Additionally, the wrench includes a grip enhancing apparatus. The grip enhancing apparatus includes a threaded nut element disposed adjacent to the lever arm, the threaded nut element having a threaded opening therein. The grip enhancing apparatus also includes a threaded shaft for extending through the opening of the handle and engaging the threaded opening of the threaded nut element. The threaded shaft can extend through the threaded nut element and contact the lever arm of the adjustable wrench, forcing the L-shaped movable jaw away from the handle and the serrated jaw of the L-shaped movable jaw is forced toward the flat serrated jaw surface.

The present disclosure is related to another adjustable wrench. The adjustable wrench includes a handle having a handle end and a flat serrated jaw surface, a projection extending from the handle having a tunnel therein for accepting the lever arm of the L-shaped movable jaw, and a grip enhancing apparatus. The grip enhancing apparatus having a cam device supported by the lever arm, the cam device having an outer perimeter wherein a portion of the outer perimeter is defined by an increased radius of the cam device.

The present disclosure is related to another embodiment of an adjustable wrench. The adjustable wrench includes a handle having a handle end and a flat serrated jaw surface, a projection extending from the handle having a tunnel therein for accepting the lever arm of the L-shaped movable jaw, and a grip enhancing apparatus. The grip enhancing apparatus having a wedge device slidably disposed on the handle, wherein the wedge device can slide between the lever arm and the handle. The grip enhancing apparatus also includes a protrusion extending from the handle having a threaded passageway therein. The grip enhancing apparatus further includes a rod with a threaded portion for engaging the threaded passageway of the protrusion.

The present disclosure is related to yet another embodiment of an adjustable wrench. The adjustable wrench includes a handle having a handle end and a flat serrated jaw surface, a projection extending from the handle having a tunnel therein for accepting the lever arm of the L-shaped movable jaw, and a grip enhancing apparatus. The grip enhancing apparatus having a tubular element to frictionally engage at least the lever arm and force the lever arm away from the handle.

The present disclosure is also related to a grip enhancing apparatus for use with an adjustable wrench. The grip enhancing apparatus includes a wedge element partially disposable between the handle of the wrench and the lever arm, the wedge element having a threaded passageway therein. The grip enhancing apparatus also includes a rod with a threaded portion for engaging the threaded passageway of the wedge element.

### BRIEF DESCRIPTION OF THE DRAWINGS

FIG. 1 is a perspective view of an adjustable wrench with an extension element and a grip enhancing apparatus constructed in accordance with the present disclosure.

FIG. 2 is a cross-sectional view of another embodiment of the adjustable wrench with an extension element and a grip enhancing apparatus constructed in accordance with the present disclosure.

FIG. 3 is a perspective view of another embodiment of the adjustable wrench with an extension element and a grip enhancing apparatus constructed in accordance with the present disclosure.

FIG. 4 is a cross-sectional view of another embodiment of the adjustable wrench with an extension element and a grip enhancing apparatus constructed in accordance with the present disclosure.

FIG. 5 is a perspective view of another embodiment of the adjustable wrench with an extension element and a grip enhancing apparatus constructed in accordance with the present disclosure.

FIG. 6 is a cross-sectional view of another embodiment of the adjustable wrench with an extension element and a grip enhancing apparatus constructed in accordance with the present disclosure.

FIG. 7 is a perspective view of another embodiment of the adjustable wrench with an extension element and a grip enhancing apparatus constructed in accordance with the present disclosure.

FIG. 8 is a perspective view of an adjustable wrench with an extension element and grip enhancing apparatus constructed in accordance with the present disclosure.

FIG. 9 is a cross-sectional view of another embodiment of the adjustable wrench with the extension element and grip enhancing apparatus constructed in accordance with the present disclosure.

FIG. 10 is a perspective view of another embodiment of the adjustable wrench with the extension element and grip enhancing apparatus constructed in accordance with the present disclosure.

FIG. 11 is a cross-sectional view of another embodiment of the adjustable wrench with the extension element and grip enhancing apparatus constructed in accordance with the present disclosure.

FIG. 12 is a perspective view of another embodiment of the adjustable wrench with the extension element and grip enhancing apparatus constructed in accordance with the present disclosure.

FIG. 13 is a cross-sectional view of another embodiment of the adjustable wrench with the extension element and grip enhancing apparatus constructed in accordance with the present disclosure.

FIG. 14 is a perspective view of another embodiment of the adjustable wrench with the extension element and grip enhancing apparatus constructed in accordance with the present disclosure.

FIG. 15 is a perspective view of another embodiment of the adjustable wrench with the extension element and grip enhancing apparatus constructed in accordance with the present disclosure.

FIG. 16 is a perspective view of another embodiment of the adjustable wrench with the extension element and grip enhancing apparatus constructed in accordance with the present disclosure.

FIG. 17 is a perspective view of another embodiment of the adjustable wrench with the extension element and grip enhancing apparatus constructed in accordance with the present disclosure.

FIG. 18 is a perspective view of another embodiment of the adjustable wrench with the extension element and grip enhancing apparatus constructed in accordance with the present disclosure.

FIG. 19 is a perspective view of another embodiment of the adjustable wrench with the extension element and grip enhancing apparatus constructed in accordance with the present disclosure.

FIG. 20 is a perspective view of another embodiment of the adjustable wrench with the extension element and grip enhancing apparatus constructed in accordance with the present disclosure.

### DETAILED DESCRIPTION OF THE DISCLOSURE

The present disclosure relates to an adjustable wrench 10 that includes a grip enhancing apparatus 12 to more efficiently engage a work object 14. The work object 14 can be anything capable of having the adjustable wrench 10 used thereon. In one embodiment, the adjustable wrench 10 can be a any type of pipe wrench known in the art.

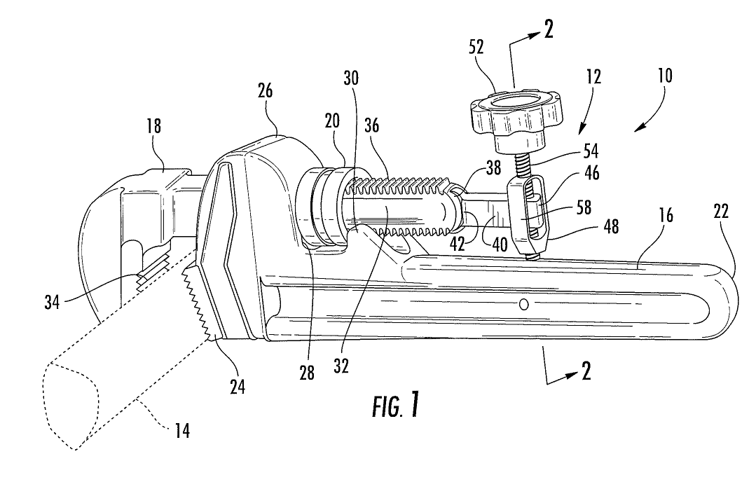

As shown in FIG. 1, an adjustable wrench 10 can include a handle 16, an L-shaped movable jaw 18 and an adjustment nut 20 for positioning the L-shaped movable jaw 18 (or hook jaw) respective of the handle 16. The handle 16 has a handle end 22, a flat serrated jaw surface 24 for engaging the work object 14, and a first projection 26 disposed on the handle 16 adjacent to the flat serrated jaw surface 24. The first projection 26 includes an adaptively-sized tunnel 28 disposed therethrough. The handle 16 can also include a second projection 30 disposed on the handle 16 that cooperates with the first projection 26 to hold and maintain the adjustment nut 20 therebetween.

The L-shaped movable jaw 18 has a lever arm 32 and a serrated jaw 34 for further engagement of the work object 14. The lever arm 32 includes threads 36 that engage the adjustment nut 20 and a terminal end 38 disposed at the opposite end of the L-shaped movable jaw 18 from the serrated jaw 34. Furthermore, the lever arm 32 of the L-shaped movable jaw 18 can be positioned within the tunnel 28 of the first projection 26 of the handle 16. The second projection 30 of the handle 16 is sized such that it does not interfere with the lever arm 32 of the L-shaped movable jaw 18 as it extends through the tunnel 28.

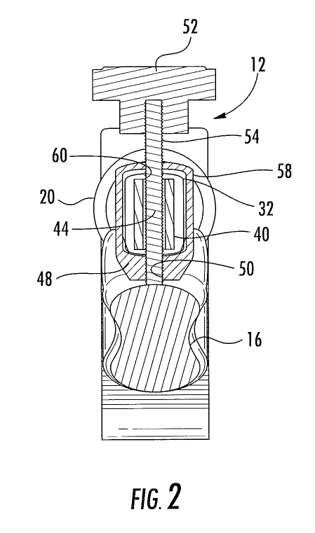

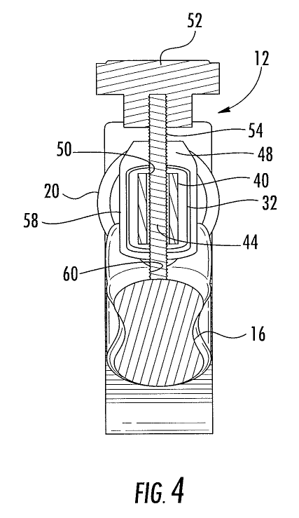

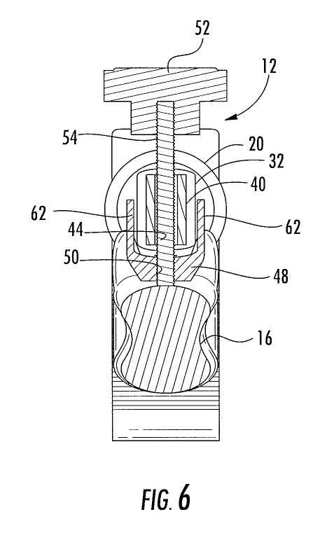

In various embodiments, shown in FIGS. 1-7, the adjustable wrench 10 can also include an extension element 40 supported on a first end 42 by the terminal end 38 of the lever arm 32 of the L-shaped movable jaw 18. The extension element 40 can have a passageway 44 disposed in a second end 46 of the extension element 40 to cooperate with the grip enhancing apparatus 12. The grip enhancing apparatus 12 cooperates with the wrench 10 to facilitate more efficient engagement of the work object 14.

More specifically, the grip enhancing apparatus 12 cooperates with the passageway 44 disposed in the second end 46 of the extension element 40. The extension element 40 can be sized and shaped in any manner such that the grip enhancing apparatus 12 can work with the wrench 10 so that sufficient gripping force can be applied to the work object 14 so that a user is not needed to maintain the wrench 10 in engagement with the work object 14 and not interfere with the traditional operation of the wrench 12. The extension element 40 can be made of any material known in the art capable of withstanding the forces that may be applied thereto. Examples of materials include, but are not limited to, hard plastic materials, metallic materials, and the like. Furthermore, the extension element 40 can be attached to the terminal end 38 of the lever arm 32 via any manner known in the art. Examples of attachment means include, but are not limited to, bolts, rivets, welded, screws, and the like.

In these embodiments, the grip enhancing apparatus 12 includes a threaded nut element 48, a threaded opening 50 disposed in a portion of the threaded nut element 48, and a threaded shaft 54 to engage the threaded opening 50 of the threaded nut element 48. In another embodiment of the present disclosure, the grip enhancing apparatus 12 can include a turn handle 52 attachable to the threaded shaft 54 or, in certain embodiments, the threaded nut 48. It should be understood that the turn handle 52 can be positioned anywhere on the threaded shaft 54 relative to the handle 16 and extension element 40 and the turn handle 52 can be any apparatus capable of being grasped by a user and be turned. In these embodiments, the second end 46 of the extension element 40 of the L-shaped movable jaw 18 has a passageway 44 disposed therein, whereby the threaded shaft 54 of the grip enhancing apparatus 12 can extend therethrough.

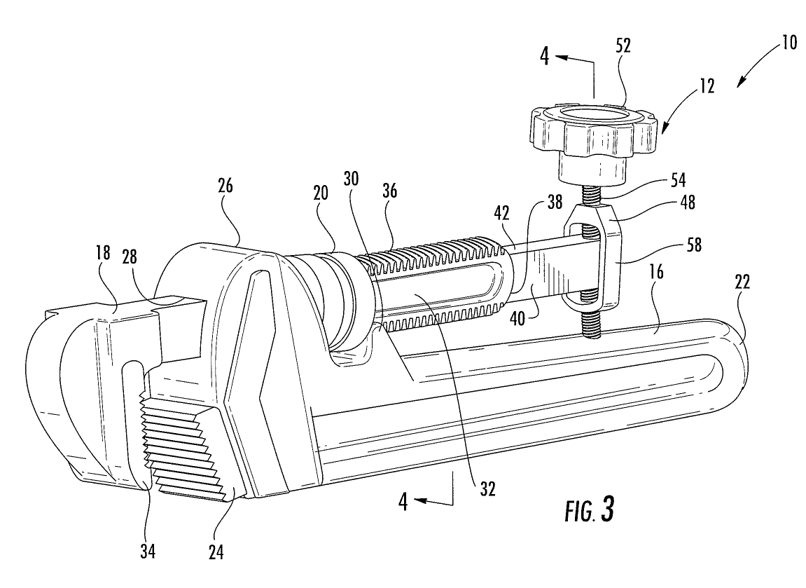

The threaded nut element 48 of the present disclosure can take on a number of shapes and sizes. In two embodiments, shown in FIGS. 1 and 3, the threaded nut element 48 includes a ring portion 58 attached thereto that extends around the second end 46 of the extension element 40 to prevent the threaded nut element 48 from turning as the turn handle 52 turns the threaded shaft 54. The ring portion 58 of the threaded nut element 48 includes an opening 60 for permitting the threaded shaft 54 to extend therethrough and generally align with the threaded opening 50 of the threaded nut element 48. In one embodiment, shown in FIG. 1, the threaded opening 50 of the threaded nut element 48 is disposed between the second end 46 of the extension element 40 and the handle 16 of the adjustable wrench 10. In another embodiment, shown in FIG. 3, the threaded opening 50 of the threaded nut element 48 is disposed on the opposite side of the second end 46 of the extension element 40 from the handle 16 of the adjustable wrench 10.

In use, the threaded shaft 54 of the grip enhancing apparatus 12 extends through the passageway 44 in the second end 46 of the extension element 40 and the opening 60 in the ring portion 58 of the threaded nut element 48 and engages the threaded opening 50 of the threaded nut element 48. The ring portion 58 of the threaded nut element 48 may contact the second end 46 of the extension element 40 and prevent the threaded nut element 48 from turning when the threaded opening 50 of the threaded nut element 48 is being engaged by the threaded shaft 54. As the threaded shaft 54 continues to engage the threaded nut element 48, the threaded shaft 54 ultimately contacts the handle 16 of the adjustable wrench 10. As the turn handle 52 of the grip enhancing apparatus 12 is turned and continues to force the threaded shaft 54 to engage the handle 16, the extension element 40 and the lever arm 32 of the L-shaped movable jaw 18 is forced away from the handle 16 and the serrated jaw 34 of the L-shaped movable jaw 18 is forced toward the flat serrated jaw surface 24 of the handle 16. At a certain point, the work object 14 is securely engaged by the serrated jaw 34 of the L-shaped movable jaw 18 and the flat serrated jaw surface 24 of the handle 16 and the wrench 10 can remain engaged on the work object 14 without a user having to maintain any pressure on the wrench 10 or hold the wrench 10.

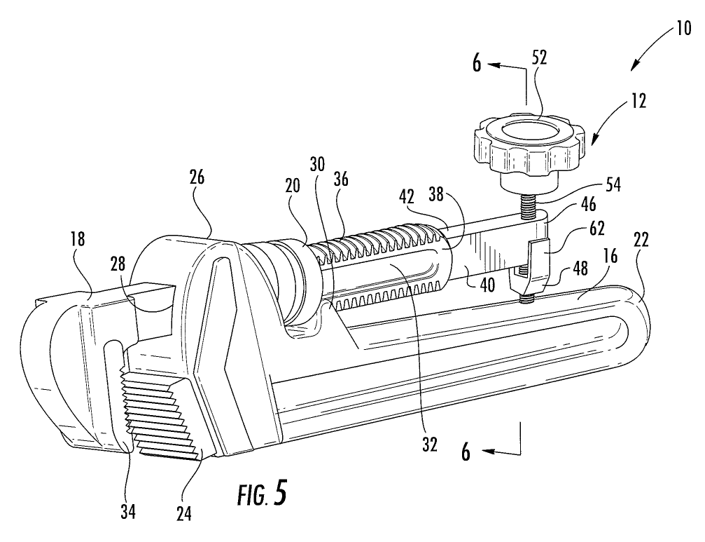

In another embodiment, shown in FIG. 5, the threaded nut element 48 includes at least one wing element 62 attached thereto that extends away from the threaded nut element 48 and adjacent to the second end 46 of the extension element 40 to prevent the threaded nut element 48 from turning as the turn handle 52 turns the threaded shaft 54. In another embodiment, the threaded nut element 48 includes two wing elements 62 extending away from the threaded nut element 48, each wing element 62 disposed adjacent to the second end 46 of the extension element 40 to prevent the threaded nut element 48 from turning as the turn handle 52 turns the threaded shaft 54. In one embodiment, the threaded opening 50 of the threaded nut element 48 is disposed between the second end 46 of the extension element 40 and the handle 16 of the adjustable wrench 10.

In use, the threaded shaft 54 of the grip enhancing apparatus 12 extends through the passageway 44 in the second end 46 of the extension element 40 and engages the threaded opening 50 of the threaded nut element 48. The at least one wing element 62 of the threaded nut element 48 may contact the second end 46 of the extension element 40 and prevent the threaded nut element 48 from turning when the threaded opening 50 of the threaded nut element 48 is being engaged by the threaded shaft 54. As the threaded shaft 54 continues to engage the threaded nut element 48, the threaded shaft 54 ultimately contacts the handle 16 of the adjustable wrench 10. As the turn handle 52 of the grip enhancing apparatus 12 is turned and continues to force the threaded shaft 54 to engage the handle 16, the extension element 40 and the lever arm 32 of the L-shaped movable jaw 18 is forced away from the handle 16 and the serrated jaw 34 of the L-shaped movable jaw 18 is forced toward the flat serrated jaw surface 24 of the handle 16. At a certain point, the work object 14 is securely engaged by the serrated jaw 34 of the L-shaped movable jaw 18 and the flat serrated jaw surface 24 of the handle 16 and the wrench 10 can remain engaged on the work object 14 without a user having to maintain any pressure on the wrench 10 or hold the wrench 10.

In yet another embodiment, shown in FIG. 7, the threaded nut element 48 is a nut, or a hexagonal nut. The threaded nut element 48 permits the threaded shaft 54 to extend therethrough. The threaded nut element 48 can be disposed between the second end 46 of the extension element 40 and the handle 16 of the adjustable wrench 10. In another embodiment, the turn handle 52 can be attached to the threaded nut 48.

In use, the threaded shaft 54 of the grip enhancing apparatus 12 extends through the passageway 44 in the second end 46 of the extension element 40 and engages the threaded nut element 48. As the threaded shaft 54 continues to engage the threaded nut element 48, the threaded shaft 54 ultimately contacts the handle 16 of the adjustable wrench 10. As the turn handle 52 of the grip enhancing apparatus 12 is turned and continues to force the threaded shaft 54 to engage the handle 16, the extension element 40 and the lever arm 32 of the L-shaped movable jaw 18 is forced away from the handle 16 and the serrated jaw 34 of the L-shaped movable jaw 18 is forced toward the flat serrated jaw surface 24 of the handle 16. At a certain point, the work object 14 is securely engaged by the serrated jaw 34 of the L-shaped movable jaw 18 and the flat serrated jaw surface 24 of the handle 16 and the wrench 10 can remain engaged on the work object 14 without a user having to maintain any pressure on the wrench 10 or hold the wrench 10.

The present disclosure also relates to other embodiments of an adjustable wrench 110 that includes various grip enhancing apparatuses 112 to more efficiently engage a work object 114. As stated herein, the adjustable wrench 110 can be any type of pipe wrench known in the art.

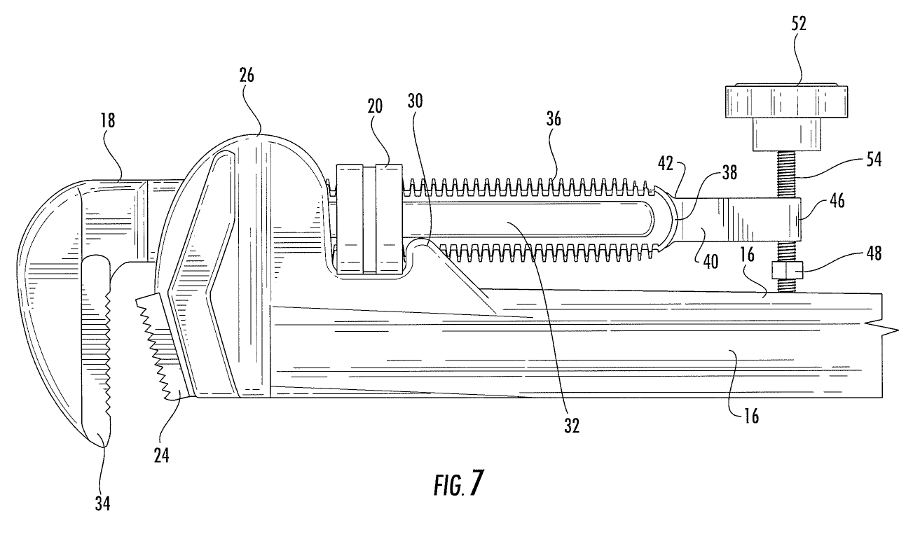

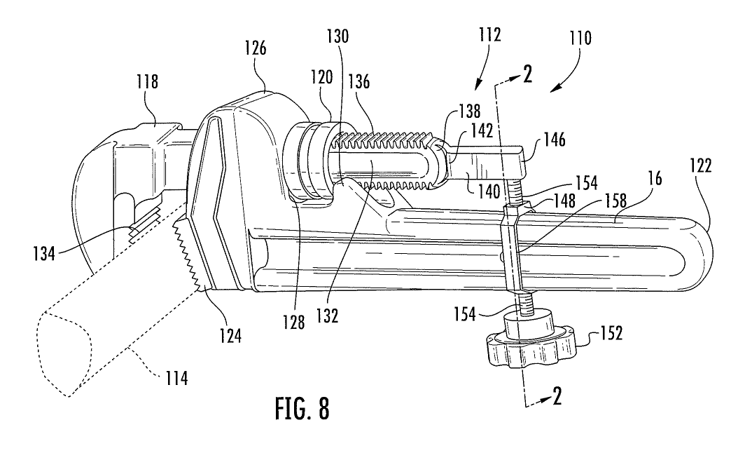

As shown in FIG. 8, an adjustable wrench 110 can include a handle 116, an L-shaped movable jaw 18 and an adjustment nut 120 for positioning the L-shaped movable jaw 118 (or hook jaw) respective of the handle 116. The handle 116 has a handle end 122, a flat serrated jaw surface 124 for engaging the work object 114, and a first projection 126 disposed on the handle 16 adjacent to the flat serrated jaw surface 124. The first projection 126 includes an adaptively-sized tunnel 128 disposed therethrough. The handle 116 can also include a second projection 130 disposed on the handle 16 that cooperates with the first projection 126 to hold and maintain the adjustment nut 120 therebetween.

The L-shaped movable jaw 118 has a lever arm 132 and a serrated jaw 134 for further engagement of the work object 114. The lever arm 132 includes threads 136 that engage the adjustment nut 120 and a terminal end 138 disposed at the opposite end of the L-shaped movable jaw 118 from the serrated jaw 134. Furthermore, the lever arm 132 of the L-shaped movable jaw 118 can be positioned within the tunnel 128 of the first projection 126 of the handle 116. The second projection 130 of the handle 116 is sized such that it does not interfere with the lever arm 132 of the L-shaped movable jaw 118 as it extends through the tunnel 128.

In various embodiments, shown in FIGS. 8-20, the adjustable wrench 110 can also include an extension element 140 supported on a first end 142 by the terminal end 138 of the lever arm 132 of the L-shaped movable jaw 118. The handle 116 also includes a passageway 144 that cooperates with a second end 146 of the extension element 140 and the grip enhancing apparatus 112 to facilitate more efficient engagement of the work object 114.

The extension element 140 can be sized and shaped in any manner such that the grip enhancing apparatus 112 can work with the wrench 110 so that sufficient gripping force can be applied to the work object 114 so that a user is not needed to maintain the wrench 110 in engagement with the work object 114 and not interfere with the traditional operation of the wrench 112. The extension element 140 can be made of any material known in the art capable of withstanding the forces that may be applied thereto. Examples of materials include, but are not limited to, hard plastic materials, metallic materials, and the like. Furthermore, the extension element 140 can be attached to the terminal end 138 of the lever arm 132 via any manner known in the art. Examples of attachment means include, but are not limited to, bolts, rivets, welded, screws, and the like.

In these embodiments, the grip enhancing apparatus 112 includes a threaded nut element 148, a threaded opening 150 disposed in a portion of the threaded nut element 148, and a threaded shaft 154 to engage the threaded opening 150 of the threaded nut element 148. In another embodiment of the present disclosure, the grip enhancing apparatus 112 can include a turn handle 152 attachable to the threaded shaft 154 or, in certain embodiments, the threaded nut 148. It should be understood that the turn handle 152 can be positioned anywhere on the threaded shaft 154 relative to the handle 16 and the extension element 140 and the turn handle 152 can be any apparatus capable of being grasped by a user and be turned. In these embodiments, the passageway 144 is disposed in the handle 116 whereby the threaded shaft 154 of the grip enhancing apparatus 112 can extend therethrough.

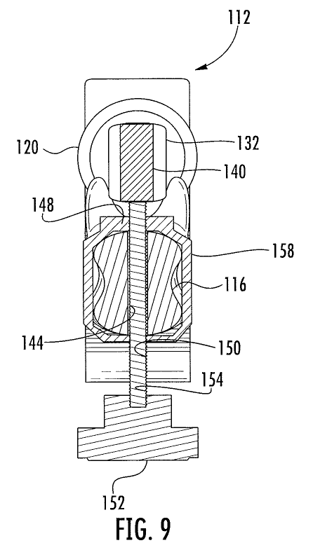

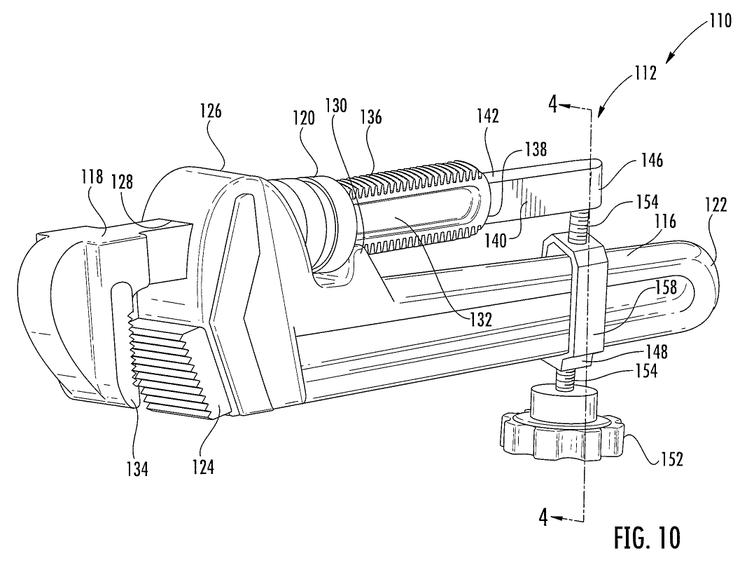

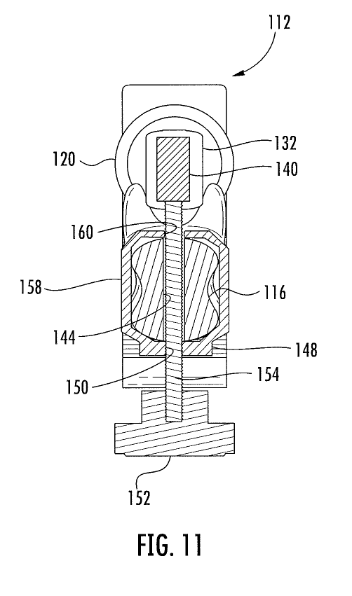

The threaded nut element 148 of the present disclosure can take on a number of shapes and sizes. In two embodiments, shown in FIGS. 8-11, the threaded nut element 148 includes a ring portion 158 attached thereto that extends around the handle 116 to prevent the threaded nut element 148 from turning as the turn handle 152 turns the threaded shaft 154. The ring portion 158 of the threaded nut element 148 includes an opening 160 for permitting the threaded shaft 154 to extend therethrough and generally align with the threaded opening 150 of the threaded nut element 148. In one embodiment, shown in FIGS. 8 and 9, the threaded opening 150 of the threaded nut element 148 is disposed between the second end 146 of the extension element 140 and the handle 116 of the adjustable wrench 110. In another embodiment, shown in FIGS. 10 and 11, the threaded opening 150 of the threaded nut element 148 is disposed on the opposite side of the handle 116 from the second end 146 of the extension element 140.

In use, the threaded shaft 154 of the grip enhancing apparatus 112 extends through the passageway 144 in the handle 116 and the opening 160 in the ring portion 158 of the threaded nut element 148 and engages the threaded opening 150 of the threaded nut element 148. The ring portion 158 of the threaded nut element 148 may contact the handle 116 and prevent the threaded nut element 148 from turning when the threaded opening 150 of the threaded nut element 148 is being engaged by the threaded shaft 154. As the threaded shaft 154 continues to engage the threaded nut element 148, the threaded shaft 154 ultimately contacts the second end 146 of the extension element 140. As the turn handle 152 of the grip enhancing apparatus 112 is turned and continues to force the threaded shaft 154 to engage the second end 146 of the extension element 140, the extension element 140 and the lever arm 132 of the L-shaped movable jaw 118 is forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

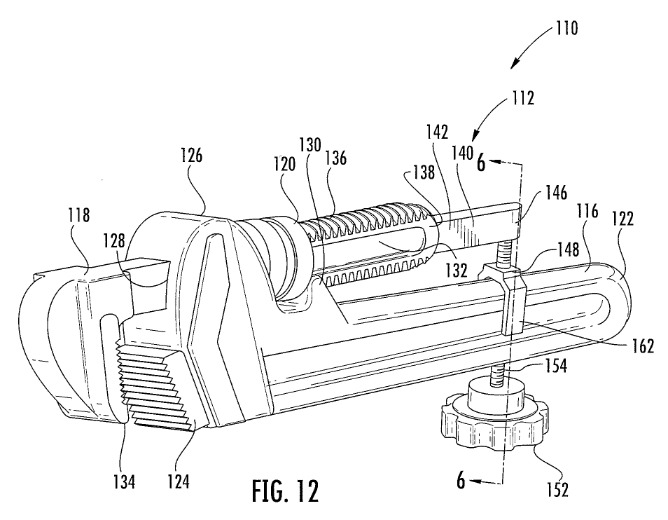

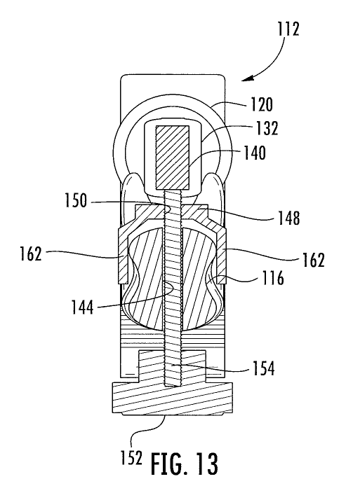

In another embodiment, shown in FIGS. 12 and 13, the threaded nut element 148 includes at least one wing element 162 attached thereto that extends away from the threaded nut element 148 and adjacent to the handle 116 to prevent the threaded nut element 148 from turning as the turn handle 152 turns the threaded shaft 154. In another embodiment, the threaded nut element 148 includes two wing elements 162 extending away from the threaded nut element 148, each wing element 162 disposed adjacent to the handle 116 to prevent the threaded nut element 148 from turning as the turn handle 152 turns the threaded shaft 154. In one embodiment, the threaded opening 150 of the threaded nut element 148 is disposed between the second end 146 of the extension element 140 and the handle 116 of the adjustable wrench 110.

In use, the threaded shaft 154 of the grip enhancing apparatus 112 extends through the passageway 144 in the handle 116 and engages the threaded opening 150 of the threaded nut element 148. The at least one wing element 162 of the threaded nut element 148 may contact the handle 116 and prevent the threaded nut element 148 from turning when the threaded opening 150 of the threaded nut element 148 is being engaged by the threaded shaft 154. As the threaded shaft 154 continues to engage the threaded nut element 148, the threaded shaft 154 ultimately contacts the second end 146 of the extension element 140. As the turn handle 152 of the grip enhancing apparatus 112 is turned and continues to force the threaded shaft 154 to engage the second end 146 of the extension element 140, the extension element 140 and the lever arm 132 of the L-shaped movable jaw 118 is forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

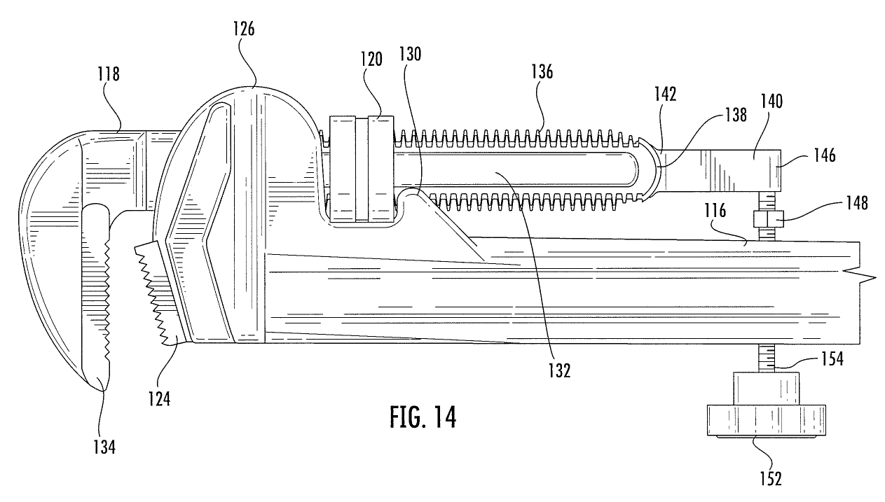

In yet another embodiment, shown in FIG. 14, the threaded nut element 148 is a nut, or a hexagonal nut. The threaded nut element 148 permits the threaded shaft 154 to extend therethrough. The threaded nut element 148 can be disposed between the second end 146 of the extension element 140 and the handle 116 of the adjustable wrench 110. In another embodiment, the turn handle 152 can be attached to the threaded nut 148.

In use, the threaded shaft 154 of the grip enhancing apparatus 112 extends through the passageway 144 in the handle 116 and engages the threaded nut element 148. As the threaded shaft 154 continues to engage the threaded nut element 148, the threaded shaft 154 ultimately contacts the second end 146 of the extension element 140. As the turn handle 152 of the grip enhancing apparatus 112 is turned and continues to force the threaded shaft 154 to engage the second end 146 of the extension element 140, the extension element 140 and the lever arm 132 of the L-shaped movable jaw 118 is forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

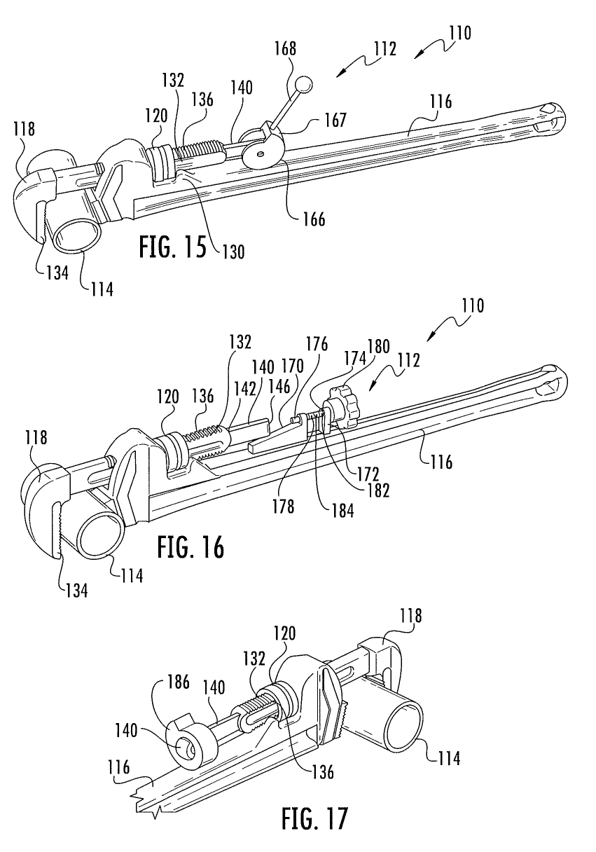

In yet another embodiment of the present disclosure, shown in FIG. 15, the grip enhancing apparatus 112 includes a cam device 166 rotatably supported by the second end 146 of the extension element 140. In this embodiment, the cam device 166 is rotated in a direction that is substantially parallel with the handle 116 of the adjustable wrench 110. The grip enhancing apparatus 112 of this embodiment further includes a leverage element 168 (or any type of handle capable of being attached to the cam device 166 and rotating the cam device 166) attached to the cam device 166 to turn the cam device 166 about the extension element 140. In this embodiment, the cam device 166 has a radius that increases over a portion of an outside perimeter 167 of the cam device 166.

In use, the extension element 140 and the lever arm 132 of the L-shaped movable jaw 118 are forced away from the handle 116 when the leverage element 168 rotates the cam device 166 such that the increased radius is positioned between the extension element 140 and the handle 116. As the leverage element 168 of the grip enhancing apparatus 112 is turned and forces the cam device 166 to engage the extension element 140, the extension element 140 and the lever arm 132 of the L-shaped movable jaw 118 are forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

In yet another embodiment of the present disclosure, shown in FIG. 16, the grip enhancing apparatus 112 includes a wedge device 170 slidably disposed on the handle 116 of the adjustable wrench 110 and under the second end 146 of the extension element 140. In this embodiment, the grip enhancing apparatus 112 also includes a protrusion 172 extending from the handle 116 having a threaded passageway 174 disposed therein. In this embodiment, the wedge device 170 is attached to a first end 176 of a rod 178. In one embodiment, the rod 178 has a turn handle 180 attached to a second end 182 of the rod 178 and a threaded portion 184 for threadably engaging the threaded passageway 174 disposed in the protrusion 172 on the wrench handle 116. It should be understood that the wedge device 170 is not required to be attached to the rod 178. The wedge device 170 could be designed such that the rod 178 contacts it and just pushes the wedge device 170 into the desired position to make the grip enhancing apparatus 112 work properly with the adjustable wrench 110.

In use, the rod 178 is turned and the threaded portion 184 of the rod 178 engages the threaded passageway 174 disposed in the protrusion 172 of the wrench handle 116, the wedge device 170 slides toward the serrated jaw 134 of the L-shaped movable jaw 118 and forces the second end 146 of the extension element 140 away from the handle 116 of the adjustable wrench 110. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

In another embodiment shown in FIG. 17, the grip enhancing apparatus 112 includes a cam device 186 that has an increased radius over a portion of the perimeter of the cam device 186 and turns about the extension element 140 in a direction that is substantially perpendicular to the length of the handle 116 of the adjustable wrench 110. The cam device 186 in this embodiment is supported by the extension element 140 and can be rotated around the extension element 140 attached to the lever arm 132.

In use, the extension element 140 is forced away from the handle 116 when the cam device 186 is rotated such that the increased radius portion of the cam device 186 is positioned between the extension element 140 and the handle 116. As the cam device 186 is turned, the increased radius of the cam device 186 forces the cam device 186 to engage the handle 116. This forces the extension element 140 away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

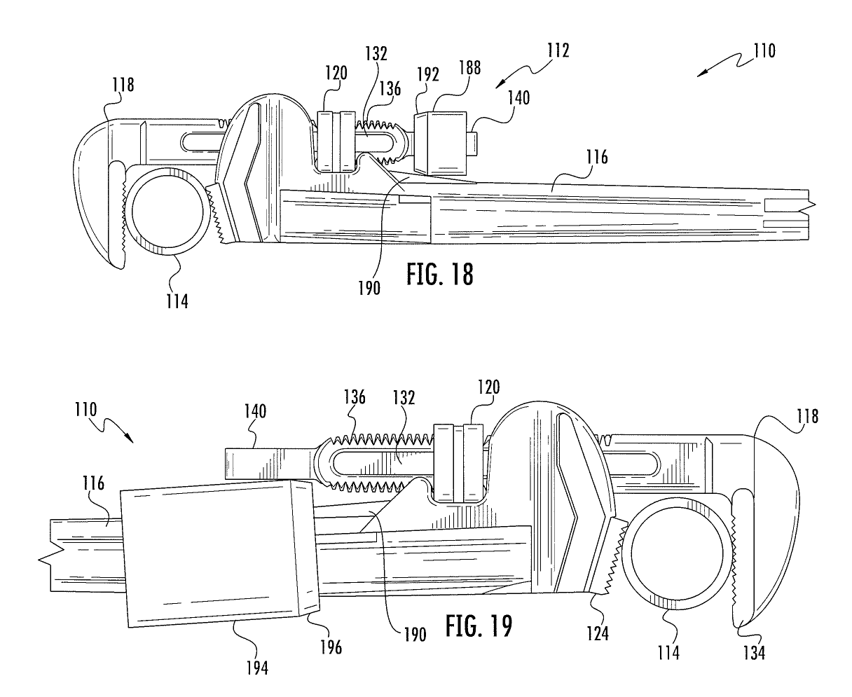

In yet another embodiment of the present disclosure, shown in FIGS. 18 and 19, the grip enhancing apparatus 12 includes a tubular element 188 sized such that it can be disposed around the extension element 140 attached to the lever arm 132. In this embodiment, the handle 116 of the adjustable wrench 110 includes an inclined portion 190 attached to the handle 116 between the extension element 140 and the handle 116. The inclined portion 190 inclines in the direction from the handle end 122 to the flat serrated jaw surface 124. In another embodiment, the tubular element 188 includes a tapered portion 192 disposed about at least a portion of the circumference of one end of the tubular element 188.

In use, the tubular element 188 can be forced by hand over the second end 146 of the extension element 140 to frictionally engage with at least the inclined portion 190 of the handle 116 and/or the extension element 140. This would force the extension element 140 attached to the lever arm 132 to be forced away from the handle 116 of the adjustable wrench 110, which would force the serrated jaw 134 of the L-shaped movable jaw 118 toward the flat serrated jaw surface 124 of the handle 116. This enables the adjustable wrench 110 to grip a work object 114 without a user having to continually apply force to the adjustable wrench 110 or hold the adjustable wrench 110 in place. In another embodiment, the terminal end 138 of the lever arm 132 is threaded and the tubular element 188 is threaded. In this embodiment, the user would screw the tubular element 188 in place such that the tapered portion 192 engages the inclined portion 190 of the wrench handle 116, as described above.

In yet another embodiment, shown in FIG. 19, the grip enhancing apparatus 112 includes a tubular element 194 sized such that it can be disposed around the handle 116 of the adjustable wrench 110. In this embodiment, the handle 116 of the adjustable wrench 110 includes the inclined portion 190 attached to the handle 116 between the extension element 140 and the handle 116. The inclined portion 190 inclines in the direction from the handle end 122 to the flat serrated jaw surface 124. In another embodiment, the tubular element 194 includes a tapered portion 196 disposed about at least a portion of the circumference of one end of the tubular element 194.

In use, the tubular element 194 can be forced by hand over the handle 116 to frictionally engage with at least the inclined portion 190 of the handle 116 and/or the extension element 140. This would force the extension element 140 attached to the lever arm 132 of the L-shaped movable jaw 118 to be forced away from the handle 116 of the adjustable wrench 110, which would force the serrated jaw 134 of the L-shaped movable jaw 118 toward the flat serrated jaw surface 124 of the handle 116. This enables the adjustable wrench 110 to grip a work object 114 without a user having to continually apply force to the adjustable wrench 110, or hold the adjustable wrench 110 in place.

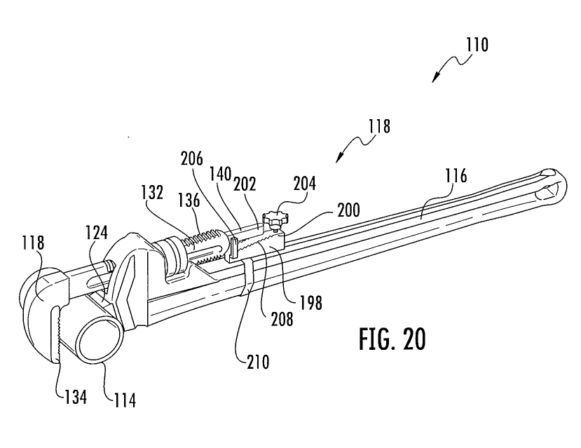

In another embodiment of the present disclosure, shown in FIG. 20, the grip enhancing apparatus 112 includes a wedge element 198 disposable on the handle 116 of the adjustable wrench 110 and under the extension element 140. In this embodiment, the wedge element 198 also includes a threaded passageway 200 disposed therein. In this embodiment, the grip enhancing apparatus 112 also includes an at least partially threaded rod 202 to engage the threaded passageway 200 disposed in the wedge element 198. In one embodiment, the rod 202 has a turn handle 204 attached thereto. In another embodiment, the wedge element 198 can include a plurality of wing elements 206 that extend from the wedge element 198 and are disposed adjacent to the extension element 140 and/or the handle 116 of the adjustable wrench 110 to prevent the wedge element 198 from turning when the rod 202 is turned. In a further embodiment, the wedge element 198 can include at least one ridge element 208 disposed on a top portion of the wedge element 198 to engage with the extension element 140. The at least one ridge element 208 prevents the wedge element 198 from sliding back when in use.

In another embodiment, the grip enhancing apparatus 112 can include an attachment apparatus 210 for selectively attaching the wedge element 198 to the handle 116 or the extension element 140. Examples include, but are not limited to Velcro®, elastic strap, and the like. It should be understood that the attachment apparatus 210 can be any device known in the art capable of securing the attachment apparatus 210 to the handle 116 or extension element 140 and permits the grip enhancing apparatus 112 to perform its intended function.

In use, the grip enhancing apparatus 112 is placed in the appropriate position relative to the extension element 140 and the handle 116. The threaded rod 202 is then turned and engages the threaded passageway 200 disposed in the wedge element 198. As the rod 202 is turned through the threaded passageway 200, the rod 202 will ultimately contact the handle 116, which raises the wedge element 198 off of the handle 116 and forces the wedge element 198 into the extension element 140. This forces the extension element 140 attached to the lever arm 132 of the L-shaped movable jaw 118 away from the handle 116 of the adjustable wrench 110. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

From the above description, it is clear that the present disclosure is well adapted to carry out the objectives and to attain the advantages mentioned herein as well as those inherent in the disclosure. While presently disclosed embodiments have been described for purposes of this disclosure, it will be understood that numerous changes may be made which will readily suggest themselves to those skilled in the art and which are accomplished within the spirit of the disclosure.

What is claimed is:

1. An adjustable wrench for engaging a work object, the wrench comprising:
a handle having a handle end and a flat serrated jaw surface;
an L-shaped movable jaw having a lever arm and a serrated jaw, the lever arm having a terminal;
a projection extending from the handle having a tunnel therein for accepting the lever arm of the L-shaped movable jaw;
an extension element extending from the terminal end of the lever arm, the extension element having an opening therein; and
a grip enhancing apparatus, the grip enhancing apparatus comprising:
a threaded nut element disposed adjacent to the extension element, the threaded nut element having a threaded opening therein; and
a threaded shaft for extending through the opening of the extension element and engaging the threaded opening of the threaded nut element, the threaded shaft extendable through the threaded nut element to contact the handle of the adjustable wrench to force the L-shaped movable jaw away from the handle and force the serrated jaw of the L-shaped movable jaw toward the flat serrated jaw surface.

2. The wrench of claim 1 wherein the grip enhancing apparatus further comprises a turn handle attached to the threaded shaft.

3. The wrench of claim 1 wherein the threaded nut element further comprises a ring portion that extends around the extension element of the L-shaped movable jaw to prevent the threaded nut element from rotating as the threaded nut is engaged by the threaded shaft, the ring portion having an opening therein for receiving the threaded shaft.

4. The wrench of claim 3 wherein the threaded nut element is positioned between the extension element and the handle.

5. The wrench of claim 3 wherein the threaded nut element is positioned on a side of the extension element that is opposite of the side nearest the handle.

6. The wrench of claim 1 wherein the threaded nut element further comprises at least one wing element extending away from the threaded nut element and Is positioned adjacent to one side of the extension element to prevent the threaded nut element from rotating as the threaded nut is engaged by the threaded shaft.

7. The wrench of claim 6 wherein the threaded nut element is positioned between the extension element and the handle.

8. The wrench of claim 6 wherein the threaded nut element is positioned on a side of the extension element that is opposite of the side nearest the handle.

9. The wrench of claim 1 wherein the threaded nut element further comprises two wing elements extending away from the threaded nut element, each wing element positioned adjacent to each side of the extension element to prevent the threaded nut element from rotating as the threaded nut is engaged by the threaded shaft.

10. The wrench of claim 9 wherein the threaded nut element is positioned between the extension element and the handle.

11. The wrench of claim 2 wherein the turn handle is attached to the threaded nut between the extension element and the handle.

12. The wrench of claim 1 wherein the threaded nut element is a hexagonal nut.

13. The wrench of claim 1 wherein the threaded nut element has a turn handle attached thereto.

14. An adjustable wrench for engaging a work object, the wrench comprising:
a handle having an opening, a handle end and a flat serrated jaw surface;
an L-shaped movable jaw having a lever arm and a serrated jaw, the lever arm having a terminal end;
a projection extending from the handle having a tunnel therein for accepting the lever arm of the L-shaped movable jaw;
an extension element extending from the terminal end of the lever arm; and
a grip enhancing apparatus, the grip enhancing apparatus comprising:
a threaded nut element disposed adjacent to the extension element, the threaded nut element having a threaded opening therein; and
a threaded shaft for extending through the opening of the handle and engaging the threaded opening of the threaded nut element, the threaded shaft extendable through the threaded nut element to contact the extension element to force the L-shaped movable jaw away from the handle and force the serrated jaw of the L-shaped movable jaw toward the flat serrated jaw surface.

15. The wrench of claim 14 wherein the grip enhancing apparatus further comprises a turn handle attached to the threaded shaft.

16. The wrench of claim 14 wherein the threaded nut element further comprises a ring portion that extends around the handle of the adjustable wrench to prevent the threaded nut element from rotating as the threaded nut is engaged by the threaded shaft, the ring portion having an opening therein for receiving the threaded shaft.

17. The wrench of claim 16 wherein the threaded nut element is positioned between the extension element and the handle.

18. The wrench of claim 16 wherein the threaded nut element is positioned on a side of the handle that is opposite of the side nearest the extension element.

19. The wrench of claim 14 wherein the threaded nut element further comprises at least one wing element extending away from the threaded nut element and positioned adjacent to one side of the handle to prevent the threaded nut element from rotating as the threaded nut is engaged by the threaded shaft.

20. The wrench of claim 17 wherein the threaded nut element further comprises at least one wing element extending away from the threaded nut element and positioned adjacent to one side of the extension element to prevent the threaded nut element from rotating as the threaded nut is engaged by the threaded shaft.

21. The wrench of claim 20 wherein the threaded nut element is positioned between the extension element and the handle.

22. The wrench of claim 19 wherein the threaded nut element further comprises a second wing element extending away from the threaded nut element, the second wing element positioned adjacent to the side of the handle to prevent the threaded nut element from rotating as the threaded nut is engaged by the threaded shaft.

23. The wrench of claim 20 wherein the threaded nut element further comprises a second wing element extending away from the threaded nut element, the second wing element positioned adjacent to the extension element to prevent the threaded nut element from rotating as the threaded nut is engaged by the threaded shaft.

24. The wrench of claim 22 wherein the threaded nut element is positioned between the extension element and the handle.

25. The wrench of claim 15 wherein the turn handle is attached to the threaded nut between the extension element and the handle.

26. The wrench of claim 14 wherein the threaded nut element is a hexagonal nut.

27. The wrench of claim 14 wherein the threaded nut element has a turn handle attached thereto.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)
